(19) United States
(12) Patent Application Publication
(10) Pub. No.: US 2011/0039602 A1
(43) Pub. Date: Feb. 17, 2011

(54) Methods And Systems For Interacting With Content On A Mobile Device

(76) Inventors: Justin McNamara, Atlanta, GA (US); Fulvio Cenciarelli, Suwanee, GA (US); Jeffrey Mikan, Atlanta, GA (US); John Lewis, Lawrenceville, GA (US)

Correspondence Address: AT&T Legal Department - WW, Patent Docketing Room 2A-207, One AT&T Way, Bedminster, NJ, 07921, US

(21) Appl. No.: 12/540,484

(22) Filed: Aug. 13, 2009

(51) Int. Cl. H04M 1/00; G06F 3/041

(52) U.S. Cl. 455/566; 345/173

(57) ABSTRACT

A mobile device for interacting with electronic content may be provided. The mobile device may include an input device. The input device may include a touch surface such as a touch screen, a touch pad, or the like. A user may perform one or more gestures on the touch surface of the input device. Additionally, the mobile device may include an accelerometer or other suitable sensing device integrated therein. The user may also perform one or more gestures with the mobile device that may be detected by the accelerometer or other suitable seasoning device integrated therein. The mobile device may then perform one or more actions on the electronic content based on the gestures detected on the touch surface and/or the accelerometer or other suitable sensing device.

### BACKGROUND

Portable electronic devices such as electronic book readers, cellular phones, Personal Data Assistants (PDAs), audiovisual portable devices such as MP3 players, or the like typically enable users thereof to interact with electronic content such as electronic books, games, or the like. For example, a user may read an electronic book and/or play a card game using such portable electronic devices. Typically, to read such a book or play such a card game the user interacts with a portable electronic device via an input device such as a button, touch screen, or the like to, for example, go to a subsequent page or card. Unfortunately, such a user interaction may not enable the user to perform an action with respect to multiple pages or cards.

Furthermore, such a user interaction may be very different from an interaction with real-world objects. For example, when a reader reads a hard copy of a book, the reader would flip the current page to precede to read the next page. If the reader wishes to skip a chapter, the reader may flip a number of pages to get to the next chapter. In contrast, when reading an electronic book on a portable electronic device, the reader would need to press a button, or following a link in an index page to navigate an electronic book.

### SUMMARY

Disclosed herein are systems and methods for interacting with content on a mobile device. The mobile device may include an input device. The input device may include a touch surface such as a touch screen, touch pad, or the like. According to an example embodiment, a user may perform one or more gestures on the touch surface of the input device to interact with, for example, electronic content such as an electronic book, a game, or the like. For example, in one embodiment, the user may press a finger down on the touch surface with various forces such that various pressure may be detected. The user may also press the finger down with a particular force and then swipe the finger in various directions or the user may swipe in various directions and maintain the finger on the touch surface. According to one embodiment, actions may be performed on the electronic content based on the gestures performed on the touch surface of the input device.

Additionally, the mobile device may include an accelerometer or other suitable sensing device integrated therein. The user may perform one or more gestures with the mobile device that may be detected by the accelerometer or other suitable seasoning device integrated therein. For example, in one embodiment, the user may tilt the mobile device. The user may also shake the mobile device. In an example embodiment, actions may be performed on the electronic content based on the gestures detected by the accelerometer or other suitable sensing device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts an example embodiment of a mobile device.

FIGS. 2A-2D depict an example embodiment of gestures with a mobile device to interact with objects of electronic content.

FIG. 3 depicts a flow diagram of an example method for interacting with content on a mobile device.

FIG. 4 depicts a flow diagram of another example method for interacting with content on a mobile device.

FIGS. 5A-5E depict another example embodiment of gestures with a mobile device to interact with objects of electronic content.

FIG. 6 depicts a flow diagram of another example method for interacting with content on a mobile device.

FIGS. 7A-7G depict another example embodiment of gestures with a mobile device to interact with objects of electronic content.

FIG. 8 depicts a flow diagram of an example method for interacting with content on a mobile device.

FIGS. 9A-9C depict another example embodiment of gestures with a mobile device to interact with objects of an application.

FIG. 10 depicts a flow diagram of another example method for interacting with content on a mobile device.

### DETAILED DESCRIPTION OF ILLUSTRATIVE EMBODIMENTS

As will be described herein, applications such as a document application, a game, or the like that may provide electronic content such as electronic books, games, music or other audio content, videos, pictures, slide shows, motion graphics, or the like may be provided by a mobile device such as a cellular phone, a Personal Data Assistant (PDA), an electronic reader, a smart phone, a mobile computer, a game console, a media player, a media recorder, a pager, a personal navigation device, or the like. In one embodiment, the mobile device may include an input device such as a touch pad, a touch screen, a keypad, a stylus, a mouse, or the like. A user may perform one or more gestures with the mobile device to interact with objects associated with the electronic content. The gestures may be mapped to an operation associated with the electronic content. For example, according to an example embodiment, a hard press or a hard press and swipe gesture may be mapped to a multi-object skip operation. Additionally, in other example embodiments, a shake gesture may be mapped to a shuffle operation and a tilt gesture may be mapped to an object skip operation.

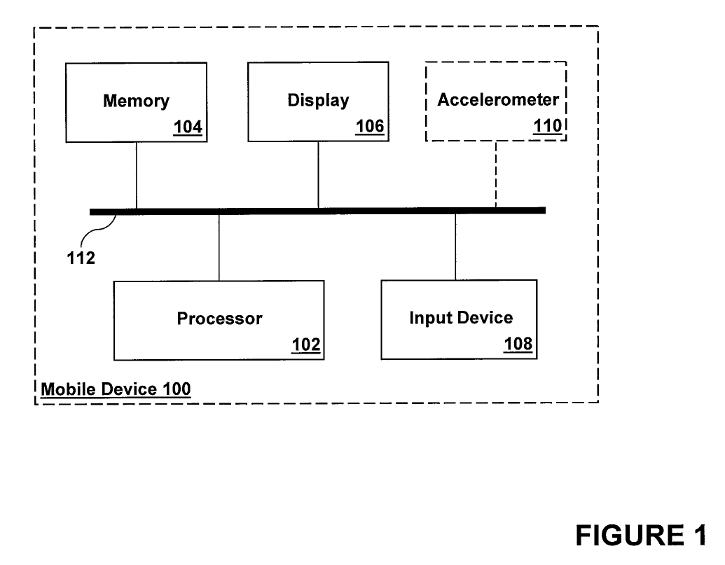

FIG. 1 depicts an example embodiment of a mobile device 100. According to example embodiments, the mobile device 100 may be any appropriate mobile device, such as, for example, a portable device, a variety of computing devices including a portable media player, e.g., a portable music player or a portable video player, such as an MP3 player, a walkman, an MP4 player, etc.; a media recorder, a portable computing device, such as a laptop, a personal digital assistant (“PDA”), an electronic reader, a portable phone, such as a cell phone of the like, a smart phone, a Session Initiation Protocol (SIP) phone, a video phone, a portable email device, a pager, a thin client, a portable gaming device, a personal navigation device, a graphing calculator, a pocket computer, a digital camera, or any other suitable portable electronic device.

The mobile device 100 may include hardware components such as a processor, a display interface including, for example, a graphics card, a storage component, a memory component, a network component, an input interface, or the like. The mobile device 100 may also include software components such as an operating system that may control the hardware components. For example, as shown in FIG. 1, the mobile device 100 may include a processor 102, a memory component 104, a display 106, and an input device 108. According to one embodiment, the mobile device may further include an accelerometer 110.

According to example embodiments, the mobile device 100 may be capable of executing a variety of computing applications. The computing applications may include an application such as an applet, a program, or other instruction set operative on the mobile device 100 to perform at least one function, operation, and/or procedure including at least one function, operation, and/or procedure. According to one embodiment, the computing applications may include an electronic book reader that may provide electronic content such as an electronic book, a game application, or the like. Additionally, the computing applications may include a gesture recognition application, which will be described in more detail below.

The mobile device 100 may be controlled by computer readable instructions that may be in the form of, for example, software. The computer readable instructions may include instructions for the mobile device 100 to store and access the computer readable instructions themselves. Such software may be executed within the processor 102 to cause the mobile device 100 to perform the processes or functions associated therewith. According to one embodiment, the processor 102 may include a standardized processor, a specialized processor, a microprocessor, or the like that may execute the computing applications. Additionally, the processor 102 may be implemented on a single-chip, multiple chips or multiple electrical components with different architectures.

In operation, the processor 102 may also fetch, decode, and/or execute instructions and may transfer information to and from other resources via a main data-transfer path or a device bus 112. Such a system bus may connect the components in the mobile device 100 and may define the medium for data exchange.

The mobile device 100 may further include a memory component 104 coupled to the main data-transfer path or the device bus 112. According to an example embodiment, the memory component 104 may include random access memory (RAM), read only memory (ROM), cache, Flash memory, a hard disk, or any other suitable storage component. The memory component 104 may include circuitry that allows information to be stored and retrieved. In one embodiment, the memory component 104 may store the computing applications including, for example, the electronic book reader application, the game application, the gestures application, or the like that may be executed by the processor 102.

The mobile device 100 may further include the display 106 that may be in communication with the processor 102 via, for example, the main data-transfer path or the device bus 112. The display 106 may be a plasma display, an electronic ink display, a liquid crystal display (LCD), a variable-graphics-array (VGA) display, a monochrome display, a cathode ray tube (CRT), or any other suitable display that may provide an interface such as visual output associated with, for example, the computing applications such as the electronic book reader application, the game application, the gestures application, or the like that may be executed by the processor 102 as described above. According to an example embodiment, the display 106 may display an interface such as a graphical user interface or application interface associated with, for example, an applet, a program, or other instruction set operative on the mobile device 100 to perform at least one function, operation, and/or procedure including at least one function, operation, and/or procedure. For example, the interface may include the electronic content including, but not limited to, electronic books, games, music or other audio content, videos, pictures, slide shows, motion graphics, or the like may be provided by a mobile device, such that a user may view the electronic content and interact therewith.

In one embodiment, the mobile device 100 may include a dual display, i. e., two displays. For example, one display may be placed on one side of the mobile device 100, and the other display may be placed on the opposite side of the mobile device 100. In other embodiments, the mobile device 100 may include more than two displays.

The mobile device 100 may also include the input device 108 that may be in communication with the processor 102 via, for example, the main data-transfer path or the device bus 112. According to one embodiment, the input device 108 may include a touch surface that may be configured to receive a touch input from a user and to provide the touch input to the processor 102 via, for example, the main data-transfer path or the device bus 112. For example, the touch surface may be a touchpad, a touch screen, or any other suitable touch surface that may be based on, for example, a suitable touch sensing technology such as capacitive sensing, resistive sensing, surface acoustic wave sensing, pressure sensing, optical sensing, or the like.

According to an example embodiment, the touch surface may recognize a single touch, multiple touches, as well as a position, direction, magnitude, or the like of the single or multiple touches on the touch surface. The touch surface may provide the touches to the processor 102 such that the processor 102 may interpret the touches using, for example, a gestures application that may be executed by the processor 102, which will be described in more detail below.

In one embodiment, the input device 108 may be a touch screen that may be positioned over or in front of the display 106. The touch screen may include the touch surface. According to an example embodiment, the touch screen may be integrated with the display 106. Alternatively, the touch screen may be a separate component.

The mobile device 100 may further be configured to recognize one or more gestures that may be applied to, for example, the input device 108. According to an example embodiment, the one or more gestures may be stylized interactions with the input device 108 that may be mapped to a particular operation associated with the mobile device 100. In one embodiment, the one or more gestures may be made through various finger motions, a stylus, or the like. The input device 108 may receive the gestures when being performed thereon and may provide the received input associated with the gestures to the processor 102.

According to an example embodiment, a gestures application that may include, for example, a set of instructions that recognizes the various gestures that may be applied to the input device 108. The gestures application may then provide other applications such as an application that may provide electronic content an action to perform based on the recognized gesture being applied to the input device 108. For example, when a user performs a gesture on the input device 108, the input such as the touches associated with the gesture may be received by the input device 108. The input device 108 may then provide the input associated with the gesture to the processor 102 via the device bus 112. The processor 102 may execute the instructions of the gestures application to, for example, perform actions associated with electronic content that may be provided to a user by another application executing on the processor 102.

Different gestures using, for example, one or more fingers, styluses, or the like may be performed on and received by the input device 108. According to example embodiments, such gestures may include a single point gesture such as a single finger or stylus touch; a multipoint gesture such as multiple fingers, a finger and a palm, multiple styluses, or the like; a static gesture such as a finger or stylus touch without motion, a dynamic gestures such as finger or stylus touch with motion; a continuous gesture such as a finger swipe, a segmented gesture such as a finger or stylus press followed by a finger or stylus swipe, a finger or stylus swipe followed by a finger or stylus press, or the like.

As shown in FIG. 1, the mobile device 100 may further include the accelerometer 110 according to an example embodiment. The accelerometer 110 may be a device that may detect movement such as an acceleration, tilt, or the like of the mobile device 110. For example, according to one embodiment, the accelerometer 110 may include a microminiaturized cantilever-type spring that may convert a force associated with the movement of the mobile device into a measurable displacement, such as the acceleration, tilting, or the like. Alternatively, the accelerometer 110 may include a heated gas bubble with one or more thermal sensors. When the mobile device 100 may be tilted or accelerated, the sensors may detect a location of the gas bubble.

In an example embodiment, the measurable displacement or the location of the gas bubble may be provided to, for example, the processor 102 such that the measurable displacement or the location of the gas bubble may be used by, for example, the gestures application executing on the processor 102. The gestures application may use the measurable displacement or the location of the gas bubble to perform one or more actions with, for example, an electronic document, which will be described in more detail below.

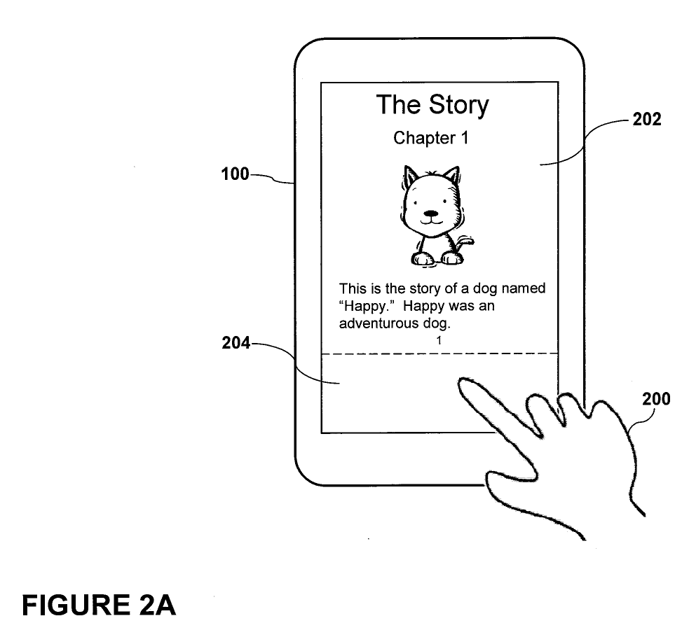

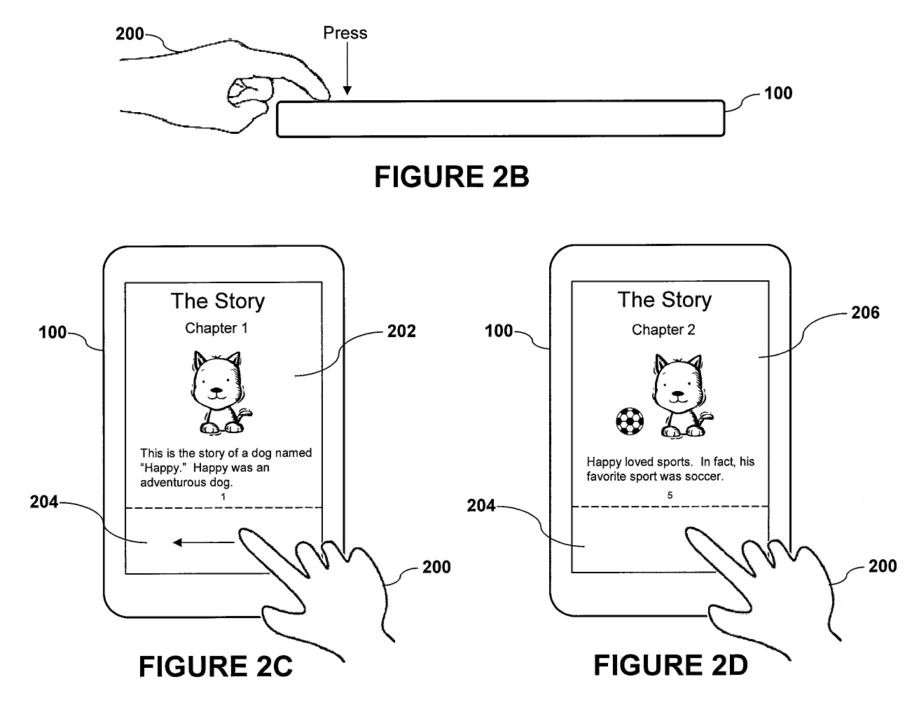

FIGS. 2A-2D depict an example embodiment of gestures that may be performed on a mobile device to interact with electronic content. For example, as described above, the mobile device 100 may provide electronic content such as an electronic document to a user. In one embodiment, the mobile device 100 may render the electronic document such that the electronic document may be output to the user via a display such as the display 106 described above with respect to FIG. 1. The user may then interact with the electronic document to, for example, read the electronic document.

According to an example embodiment, the electronic document may include a plurality of objects that may be defined or arranged in a sequential order. For example, in one embodiment, the electronic document may be an electronic book that may include a plurality of pages. The pages may be defined or arranged in a sequential order such that a first page may be followed by a second page, the second page may be followed by a third page, and so on. Thus, according to an example embodiment, the electronic document may include a plurality of objects that may be defined or arranged in a sequential order in a manner similar to a book.

In one embodiment, the user may perform one or more gestures with the mobile device 100 to interact with the electronic document including the plurality of objects. For example, as shown in FIG. 2B, a user may press down on a touch surface 204 using a finger 200 and, as shown in FIG. 2C, the user may swipe the finger 200 in various directions on the touch surface 204. According to one embodiment, the user may view or read different objects by pressing down on the touch surface 204 with the finger 200 and swiping the finger 200 in various directions, which will be described in more detail below.

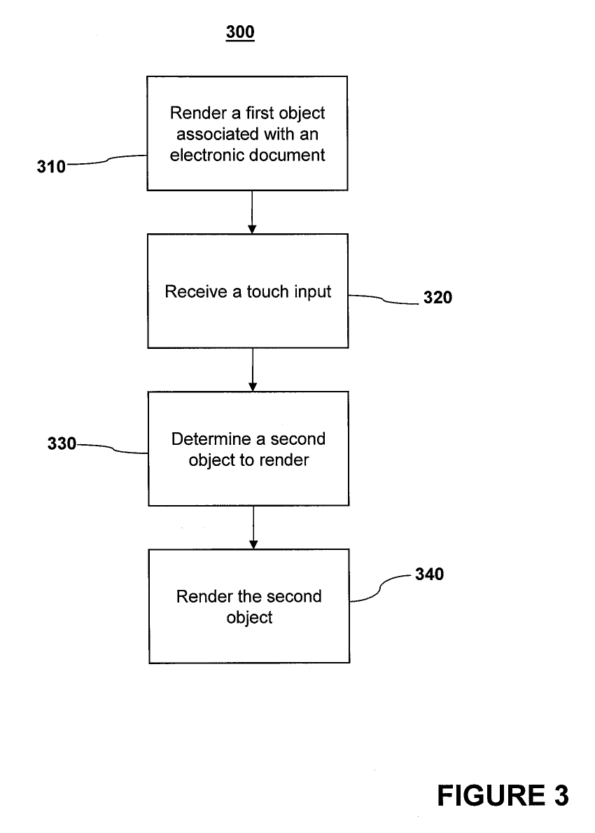

FIG. 3 depicts a flow diagram of an example method 300 for interacting with content on a mobile device. The example method 300 may be implemented using, for example, the mobile device 100 described above with respect to FIGS. 1 and 2A-2D. At 310, a first object associated with an electronic document may be rendered. For example, a mobile device may render an electronic document such that the electronic document may be output to a user via a display. As described above, according to an example embodiment, the electronic document may include a plurality of objects defined or arranged in a sequential order. At 310, a first object of the plurality of objects may be rendered such that the first object may be output to the user via the display.

In one embodiment, the first object may be a first object in the sequential order of the electronic document. For example, as described above, the electronic document may be an electronic book. The first object may be the first page of the electronic book.

According to another embodiment, the first object may be a previously viewed object. For example, the user may exit an application such as an electronic reader application that may provide an electronic document to place a telephone call, answer a telephone call, interact with other applications on the mobile device, or the like. In one embodiment, after re-launching the application, the first object may be the last object viewed by the user before the user had previously exited the application. For example, the first object may be the last page viewed or read by the user of the electronic book before exiting the application such as the electronic reader application that may provide the electronic book to the user.

As shown in FIG. 2A, a first object 202 associated with an electronic document may be rendered at 310. For example, the mobile device 100 may render the first object 202 such that the first object 202 may be output to a user via the display 106. As shown in FIG. 2A, the electronic document may be an electronic book such that the first object 202 may be the first page of the electronic book.

Referring back to FIG. 3, at 320, a touch input may be received. For example, the user may perform one or more gestures with the mobile device to interact with the electronic document. According to an example embodiment, the mobile device may receive the performed gestures via an input device that may be used by a user to interact with the mobile device. For example, the input device may include a touch surface such as a touch pad, a touch screen, or the like. The user may interact with the touch surface by, for example, pressing a finger on the touch surface. The user may also interact with the touch surface by swiping the finger in various directions. The mobile device may receive a pressure associated with the finger being placed on the touch surface of the input device as well as the direction of the finger being swiped on the touch surface as the touch input.

For example, as shown in FIG. 2B, a user may interact with the touch surface 204 by pressing a finger 200 on the touch surface 204 that may be included in the input device 108 described above with respect to FIG. 1. According to an example embodiment, a pressure may be sensed based on the force the user may use to press the finger 200 on the touch surface 204. The user may also swipe the finger 200 on the touch surface 204 in various directions. For example, as shown in FIG. 2C, the user may swipe the finger 200 in a first direction as indicated by the arrow. According to an example embodiment, the touch input received at 320 may include the pressure of the finger 200 on the touch surface 204 and the first direction of the swipe as indicated by the arrow of the finger 200 on the touch surface 204.

Referring back to FIG. 3, at 330, a second object to render may be determined. For example, the mobile device may receive the touch input and may determine another object to render. According to one embodiment, the second object may be based on the pressure and the direction of the swipe of the received touch input. For example, as described above, the mobile device may include a gestures application. The gestures application may receive the touch input to determine an action such as an object to render with respect to, for example, the electronic document. In an example embodiment, the gestures application may compare the pressure and the direction of the swipe of the touch input received at 320 with a list of suitable actions including, for example, scrolling from the first object to the second object which may include skipping a number of objects between the first object and the second object in the sequential order.

According to one embodiment, the number of objects to skip between the first and the second object may be defined by the mobile device. For example, the mobile device may track a user's interactions with the electronic document via the application such as the electronic book reader application that may provide the electronic document to the user. If a user routinely skips, for example, three objects when reading or viewing the electronic document, the mobile device may set the number of objects to skip two objects, three objects, or the like when performing a gesture such as pressing and swiping that may be associated with the touch input received at 320.

In another example embodiment, the number of objects to skip between the first and the second object may be defined by the user. For example, the user may interact with the application such as the electronic reader application that may provide the electronic document to set the number of pages to skip when performing a gesture such as pressing and swiping that may be associated with the touch input received at 320.

As shown in FIGS. 2A-2D, the mobile device 100 may use the pressure that may be sensed by pressing the finger 200 on the touch surface 204 and the first direction of the swipe of the finger 200 to determine a second object to render of the plurality of objects at 330. For example, after pressing the finger 200 on the touch surface 204 with a force that may be sensed, as shown in FIG. 2B, the user may then swipe the finger 200 in the first direction as indicated by the arrow in FIG. 2C. The mobile device 100 may use the pressure of the finger 200 and the first direction of the swipe of the finger 200 to determine a second object to render as described above.

At 340, the second object may be rendered. For example, the mobile device may render the second object such that the second object may be output to the user via the display. As described above, in one embodiment, the second object may be another page in an electronic book. The user may then view or read the second object, perform additional gestures such as pressing and swiping that may be received by the mobile device 100 in a second touch input to be directed to other objects in the electronic document, or perform any other suitable action to interact with the electronic document.

In one embodiment, after the second object may be rendered at 340, the user may press and swipe the finger on the touch surface again such that a second touch input may be received. As described above, the gestures application may receive the second touch input and may determine another object to render. For example, the second touch input may include a pressure and a direction of a swipe opposite of the touch input received at 320. The gestures application may use the pressure and the direction of the swipe in the opposite direction of the touch input received at 320 to determine that the first object may be re-rendered by the mobile device.

As shown in FIG. 2D, a second object 206 of the plurality of objects of the electronic document may be rendered by the mobile device 100 at 340 such that the second object 206 may be provided to the user via the display 106. As described above, the second object 206 may be based on the gestures such as the sensed pressure and the direction of the touch input received via the touch surface 204.

In an example embodiment, the second object 206 may not be adjacent to the first object 202 in the sequential order of the plurality of objects of the electronic document. For example, as described above, the first object 202 may include a first page of an electronic book as shown in FIG. 2A whereas the second object 206 may include the fifth page of the electronic book as shown in FIG. 2D.

According to an example embodiment, after the second object 206 may be rendered at 340, the user may press and swipe the finger 200 on the touch surface 204 again such that a second touch input may be received. For example, the user may press the finger 200 on the touch surface 204 as shown in FIG. 2B. The user may then swipe the finger 200 in, for example, a direction corresponding to arrow shown in FIG. 2C such that a third object to render may be determined. In one embodiment, the third object may be the tenth object such as the tenth page of the electronic document. Alternatively, the user may press the finger 200 on the touch surface 204 as shown in FIG. 2B and swipe the finger 200 in a direction opposite of the arrow shown in FIG. 2C such that the first object 202 shown in FIG. 2A may be re-rendered.

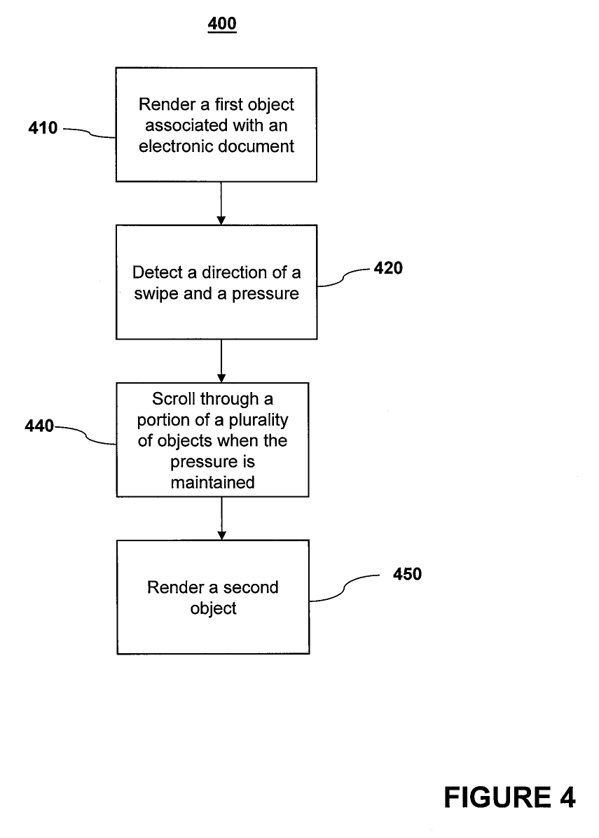

FIG. 4 depicts a flow diagram of another example embodiment for interacting with content on a mobile device. The example method 400 may be implemented using, for example, the mobile device 100 described above with respect to FIGS. 1 and 2A-2D.

At 410, a first object associated with an electronic document may be rendered. For example, a mobile device may render an electronic document such that the electronic document may be output to a user via a display. As described above, according to an example embodiment, the electronic document may include a plurality of objects defined or arranged in a sequential order. At 410, a first object of the plurality of objects may be rendered such that the first object may be output to the user via the display. As described above, the first object may be an initial object such as first page in the sequential order of the electronic document or a previously viewed object such as the last viewed page as described above.

As shown in FIG. 2A, the first object 202 associated with an electronic document may be rendered at 410. For example, the mobile device 100 may render the first object 202 such that the first object 202 may be output to a user via the display 106. As described above, the electronic document may be an electronic book. As shown in FIG. 2A, the first object 202 may be the first page of the electronic book.

Referring back to FIG. 4, at 420, a direction of a swipe and a pressure on a touch surface may be detected. For example, the user may perform one or more gestures with the mobile device to interact with the electronic document. According to an example embodiment, the mobile device 100 may receive the performed gestures via an input device that may be used by a user to interact with the mobile device. For example, the input device may include a touch surface such as a touch pad, a touch screen, or the like. The user may interact with the touch surface by, for example, by swiping a finger in various directions. The user may also interact with the touch surface by pressing and maintaining the pressed finger on the touch surface. The mobile device may receive the direction of the swipe of the finger on the touch surface and a pressure associated with the finger maintained on the touch surface as the touch input.

According to one embodiment, the user may swipe the finger 200 on the touch surface 204 in the first direction as indicated by the arrow shown in FIG. 2C. The user may then hold the finger 200 on the touch surface 204 as shown in FIG. 2B such that a pressure may be maintained or sensed on the touch surface 204. At 420, the swipe of the finger 200 in the first direction and the pressure of the finger 200 may be detected by the touch surface 204.

At 430, when the pressure of the finger on the touch surface may be maintained, a portion of the plurality of objects in the sequential order may be scrolled through in the direction of the swipe of the finger at 440. For example, when the finger remains in contact with the touch surface at a desired pressure, a portion of the objects beginning with the first object that may be rendered at 410 may be scrolled through in the direction of the swipe of the finger. According to an example embodiment, the portion of the plurality of objects may continue to be scrolled through until the pressure may not be maintained on the touch surface.

As shown in FIGS. 2B-2C, when the finger 200 remains in contact with the touch surface 204 at a desired pressure, a portion of the objects beginning with the first object 202 may be scrolled through in the direction of the swipe of the finger 200. The portion may continue to be scrolled through until the presser may not be maintained on the touch surface 204.

In one embodiment, the pressure may be maintained at 430 when the pressure of the finger 200 on the touch screen 204 exceeds a threshold pressure defined by the mobile device 100. For example, as described above, the mobile device 100 may include a gestures application that may include instructions that may be executed to determine an action such as an object to render, a portion of objects to scroll through, or the like to perform with respect to, for example, the electronic document. In an example embodiment, the gestures application may define a threshold pressure that may be used to determine whether to scroll through a portion of the plurality of objects. When the pressure detected, at 420, exceeds the threshold pressure, the gestures application may provide an instruction or a signal to the electronic document application such that the electronic document application may scroll through the portion of the plurality of objects in the direction of the swipe of the finger. For example, as shown in FIG. 2B, when the finger 200 remains in contact with the touch surface 204 at a pressure that exceeds the threshold pressure, a portion of the objects beginning with the first object 202 that may be rendered at 410 may be scrolled through in the direction of the swipe of the finger 200 as indicated by the arrow in FIG. 2C. According to an example embodiment, the portion of the plurality of objects may continue to be scrolled through until the pressure that exceeds the threshold pressure may not be maintained on the touch surface 204.

Referring back to FIG. 4, at 440, when the pressure may not be maintained on the touch surface, a second object may be rendered at 450. For example, when the user lifts the finger off the touch screen, the scrolling of the portion of the plurality of objects may stop. A second object that may be adjacent to the last object in the portion of the plurality of objects scrolled through may then be rendered at 450.

As shown in FIG. 2C, when the pressure may not be maintained on the touch surface 204, a second object 206 may be rendered at 450. For example, when the user lifts the finger 200 off the touch screen, the scrolling of the portion of the plurality of objects may stop. A second object 206 that may be adjacent to the last object in the portion of the plurality of objects scrolled through may then be rendered at 450

According to one embodiment, the pressure may not be mainlined when the pressure of the finger 200 on the touch surface 204 no longer exceeds the threshold pressure that may be defined by the mobile device. For example, as described above, the mobile device 100 may include a gestures application. The gestures application may receive the touch input to determine an action such as an object to render with respect to, for example, the electronic document. In an example embodiment, the gestures application may compare the pressure of the touch input received at 440 with a list of suitable actions including, for example, stopping scrolling and rendering a second object. Thus, in one embodiment, at 440, when the pressure no longer exceeds the threshold pressure, the second object 206 may be rendered at 450.

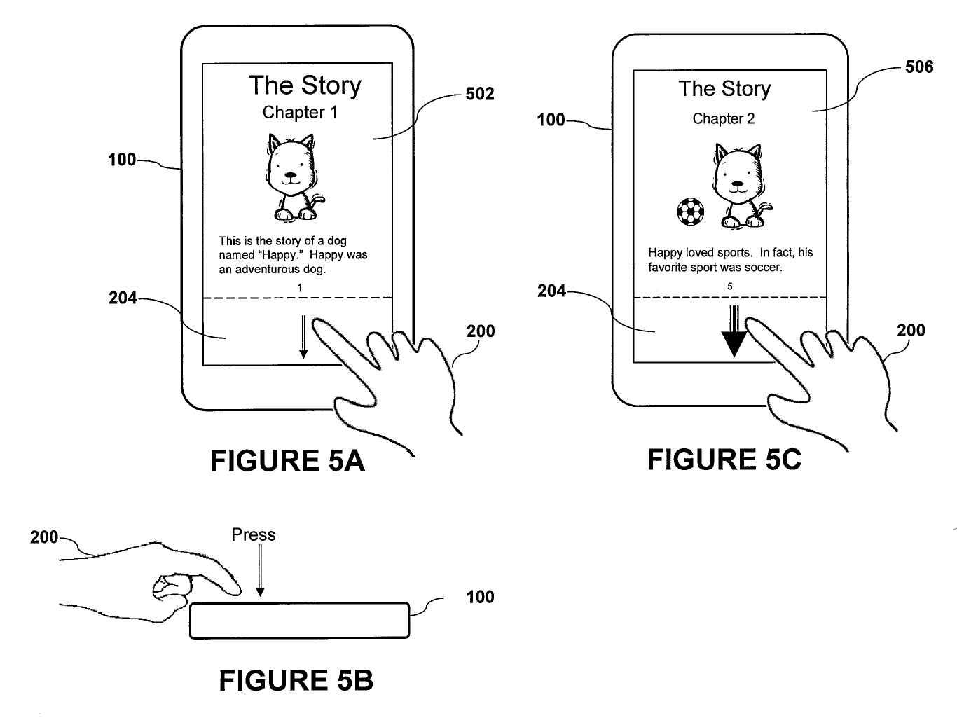

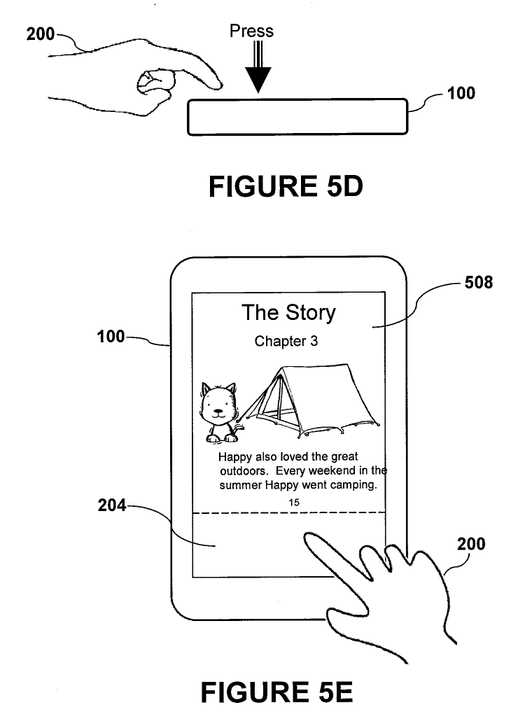

FIGS. 5A-5E depict another example embodiment of gestures with a mobile device 100 to interact with objects of electronic content. For example, as described above, the mobile device 100 may provide electronic content such as an electronic document to a user. In one embodiment, the mobile device 100 may render the electronic document such that the electronic document may be output to the user via a display such as the display 106 described above with respect to FIG. 1. The user may then interact with the electronic document to, for example, read the electronic document.

According to an example embodiment, the electronic document may include a plurality of objects that may be defined or arranged in a sequential order. For example, in one embodiment, the electronic document may be an electronic book that may include a plurality of pages. The pages may be defined or arranged in a sequential order such that a first page may be followed by a second page, the second page may be followed by a third page, and so on. Thus, according to an example embodiment, the electronic document may include a plurality of objects that may be defined or arranged in a sequential order in a manner similar to a book.

As described above, the user may perform one or more gestures with the mobile device 100 to interact with the electronic document including the plurality of objects. For example, as shown in FIGS. 5B and 5D, a user may press down on the touch surface 204 using the finger 200. According to an example embodiment, the touch surface 204 may include a pressure sensor integrated therein or attached thereon such that a pressure may be detected based on the force in which the finger 200 may be pressed down on the touch surface. The detected pressure may then be used to perform different actions such as scrolling from a first object to a second object, or the like with the electronic document. For example, the finger 200 may be pressed down on the touch surface 204 with different forces as indicated by the magnitudes of the arrows in FIGS. 5B and 5D to, for example, view or read different objects associated with the electronic document, which will be described in more detail below.

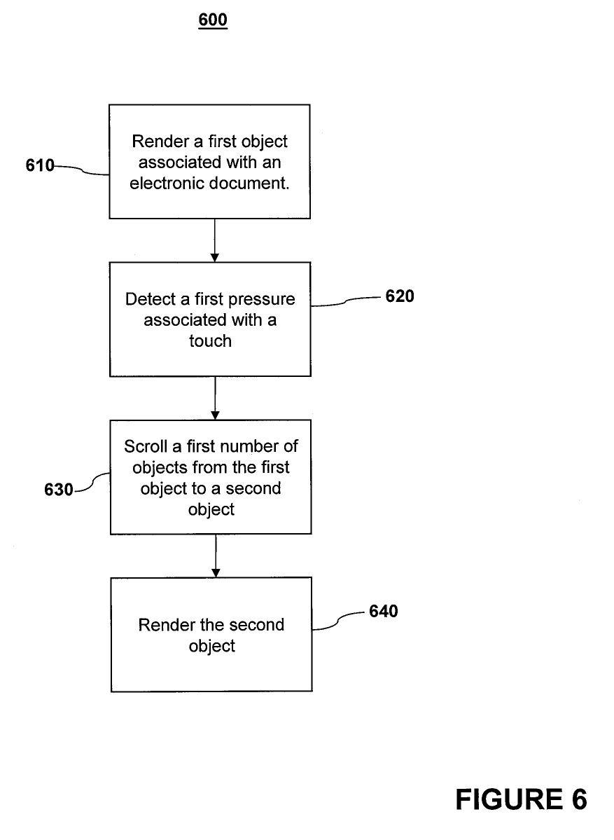

FIG. 6 depicts a flow diagram of an example method for interacting with content on a mobile device. The example method 600 may be implemented using, for example, the mobile device 100 described above with respect to FIGS. 1 and 5A-5E.

At 610, a first object associated with an electronic document may be rendered. For example, as described above, a mobile device may render an electronic document such that the electronic document may be output to a user via a display. As described above, according to an example embodiment, the electronic document may include a plurality of objects. At 610, a first object of the plurality of objects may be rendered such that the first object may be output to the user via the display 106.

In one embodiment, the first object may be a first object in the electronic document. For example, as described above, the electronic document may be an electronic book. The first object may be the first page of the electronic book.

According to another embodiment, the first object may be a previously viewed object. For example, the user may exit an application such as the electronic reader application that may provide the electronic document to place a telephone call, answer a telephone call, interact with other applications on the mobile device, or the like. In one embodiment, after re-launching the application, the first object may be the last object viewed by the user before the user had previously exited the application. For example, as described above, the electronic document may be an electronic book. The first object may be the last page viewed or read by the user of the electronic book before exiting the application that may provide the electronic book to the user.

As shown in FIG. 5A, a first object 502 associated with an electronic document may be rendered at 610. For example, the mobile device 100 may render the first object 502 such that the first object 502 may be output to a user via the display 106. As described above, the electronic document may be an electronic book. As shown in FIG. 5A, the first object 502 may include the first page of the electronic book.

At 620, a first pressure associated with a touch input may be detected. For example, as described above, the user may perform one or more gestures with the mobile device to interact with the electronic document. According to an example embodiment, the mobile device may receive the performed gestures via an input device that may be used by a user to interact with the mobile device. The input device may include a touch surface such as a touch pad, a touch screen, or the like. According to an example embodiment, the touch surface may include a pressure sensing device integrated therein or attached thereto that may be used to determine a pressure associated with force being applied to the touch surface. For example, the user may interact with the touch surface by, for example, pressing a finger down on the touch surface with a particular force. The touch surface may then detect the first pressure associated with the force in which the finger may be pressed down on the touch surface according to one embodiment.

As shown in FIG. 5B, the user may press the finger 200 down on the touch surface 204 with a first force as indicated by the magnitude of the arrow such that a first pressure associated with the touch input of the finger 200 may be detected at 620.

At 630, a first number of objects may be scrolled from the first object to a second object. For example, in one embodiment, the first number of objects may include a portion of the plurality of objects of the electronic document that may be skipped between the first object to the second object. As described above, according to an example embodiment, the electronic document may include an electronic book. At 630, the first number of objects may include a number of pages such as four pages, five pages, or the like may be skipped from the first page to reach another page in the electronic book such as the fifth page, sixth page, or the like. As shown in FIG. 5C, the second object 506 may include the fifth page of the electronic book.

According to one embodiment, the first number of objects scrolled from the first object to the second object may be based on the first pressure detected at 620. For example, as described above, the touch surface may detect various pressures associated with a force being applied by the finger using a pressure sensing device. The mobile device may receive the detected pressure as the touch input. According to an example embodiment, the mobile device may include a gestures application that may be executed thereon. As described above, the gestures application may include instructions. The gestures application may receive the touch input to determine an action such as to render an object with respect to, for example, the electronic document. In an example embodiment, the gestures application may compare the pressure of the touch input received at 620 with a list of suitable actions including, for example, scrolling from the first object to the second object which may include skipping a number of objects between the first object and the second object in the sequential order.

In one embodiment, the number of objects to skip between the first and the second objects corresponding to a pressure associated with a touch input may be defined by the mobile device. For example, the mobile device may track a user's interactions with the electronic document via the application such as an electronic book reader application that may provide the electronic document to the user. If a user routinely presses the touch surface with a certain magnitude of force to skip, for example, three objects when reading or viewing the electronic document, the mobile device may set the number of objects to skip two objects, three objects, or the like, when detecting the user performing a gesture such as pressing with the certain magnitude of force. For example, at 620, the mobile device may detect a pressure with a magnitude of force as indicated the arrow shown in FIG. 5B, and scroll, for example, four pages of the electronic book, where the number four is defined by the mobile device.

In another example embodiment, the number of objects to skip between the first and the second objects corresponding to a pressure associated with a touch input may be defined by the user. For example, the user may interact with the application that may provide the electronic document to set the number of pages to skip when performing a gesture such as pressing with a certain magnitude of force. For example, the user may indicate to the electronic reader application that when the user presses the touch surface with a magnitude of force as indicated the arrow in FIG. 5B, for example, four pages of the electronic book should be scrolled.

As shown in FIGS. 5A-5C, at 630, multiple objects such as 4 pages between the first object 502 and the second object 506 in the sequential order may be skipped based on the touch input received at 620.

At 640, the second object may be rendered. For example, the mobile device may render the second object such that the second object may be output to the user via the display. As described above, in one embodiment, the second object may include another page in an electronic book that may not be adjacent to the first object in a sequential order.

For example, as shown in FIG. 5C, the mobile device 100 may render the second object 506 such that the second object may be output via the display of the mobile device 100 at 640.

According to an example embodiment, the user may then view or read the second object, perform additional gestures such as pressing with a certain magnitude of force that may be received by the mobile device in a second touch input to be directed to other objects in the electronic document, or perform any other suitable action to interact with the electronic document. For example, in one embodiment, after the second object may be rendered at 640, the user may press on the touch surface again such that a second touch input may be received. As described above, the gestures application may receive the second touch input and may determine another object to render. For example, the second touch input may include a pressure with a second force. In one embodiment, the second force may be of greater magnitude than the first force of the first press detected at 620. The gestures application may then determine a third object such as a third ob to render based on the magnitude of magnitude of the second force detected.

For example, the user may press the finger 200 down on the touch surface 204 with the second force as indicated by the magnitude of the arrow in shown FIG. 5D. As indicated by the magnitude of the arrows in FIG. 5B and FIG. 5D, for example, the second force may be greater than the first force applied to the touch surface 204.

In one embodiment, the gestures application may compare the first force associated with the first touch input with the second force associated with second touch input, and determine that the second number of objects should be greater than the first number of objects scrolled at 630. As shown in FIG. 5C, the second object 506 of the plurality of objects of the electronic document may be rendered by the mobile device 100 such that the second object 506 may be provided to the user via the display 106. As described above, the second object 506 may be based on the gestures such as the sensed pressure received via the touch surface 204 at 620. For example, the first object 502 may include a first page of an electronic book as shown in FIG. 5A and the second object 506 may include the fifth page of the electronic book as shown in FIG. 5C. Accordingly, four pages of the electronic document, for example, may be scrolled in response to the first pressure received at 620. As indicated by the magnitude of the arrows in FIG. 5B and FIG. 5D, for example, the second force may be greater than the first force applied to the touch surface 204. As such, in response to the second pressure with a greater force, 10 pages of the electronic document may be scrolled. Alternatively, if the second force detected is less than the first force, fewer pages, for example, one page, two pages or the like may be scrolled in response to the second force detected.

As described above, the number of objects to skip between the second and the third objects corresponding to a pressure associated with a touch input may be defined by the mobile device, may be defined by the user, or the like.

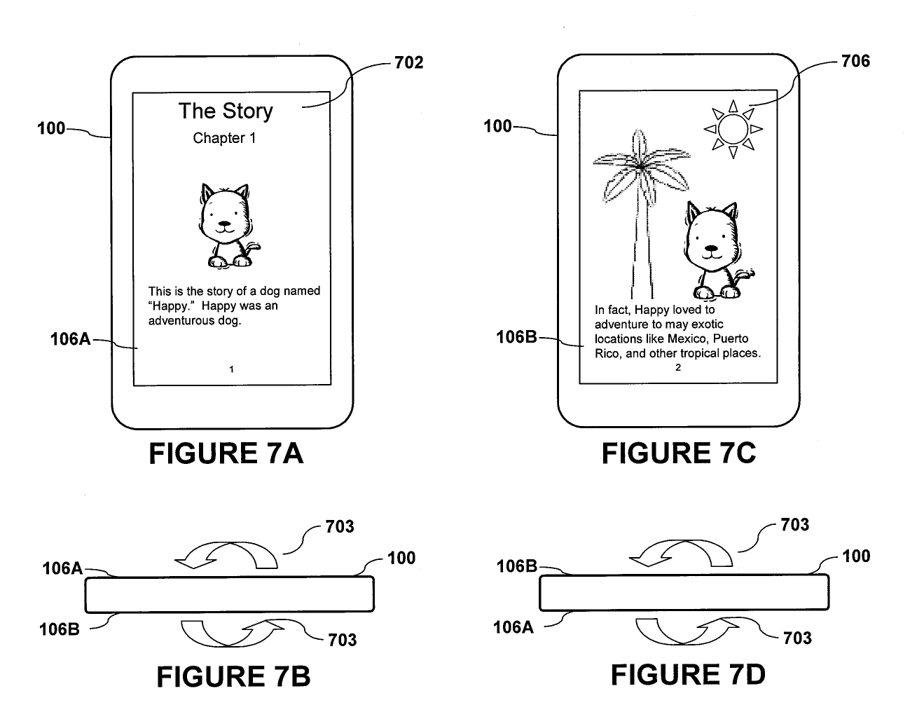

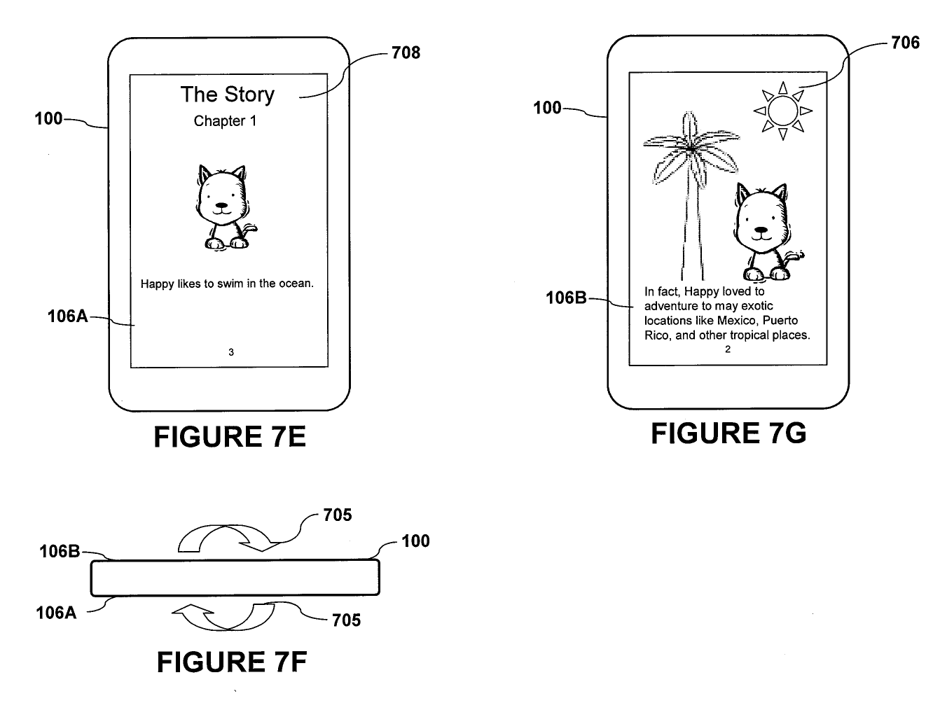

FIGS. 7A-7G depict another example embodiment of gestures with a mobile device 100 to interact with objects of electronic content. For example, as described above, the mobile device 100 may provide electronic content such as an electronic document to a user. In one embodiment, the mobile device 100 may render the electronic document such that the electronic document may be output to the user via a display such as the display 106 described above with respect to FIG. 1. The user may then interact with the electronic document to, for example, read the electronic document.

According to an example embodiment, the electronic document may include a plurality of objects that may be defined or arranged in a sequential order. For example, in one embodiment, the electronic document may be an electronic book that may include a plurality of pages. The pages may be defined or arranged in a sequential order such that a first page may be followed by a second page, the second page may be followed by a third page, and so on. Thus, according to an example embodiment, the electronic document may include a plurality of objects that may be defined or arranged in a sequential order in a manner similar to a book.

In one embodiment, the user may perform one or more gestures with the mobile device 100 to interact with the electronic document including the plurality of objects. According to an example embodiment, and as shown in FIG. 1, the mobile device 100 may include an accelerometer 110 therein or attached thereon. The accelerometer 110 may be a device that may detect movement such as an acceleration, tilt, or the like of the mobile device 100. According to one embodiment, the user may view or read different objects by tilting the mobile device 100 in various directions, which will be described in more detail below.

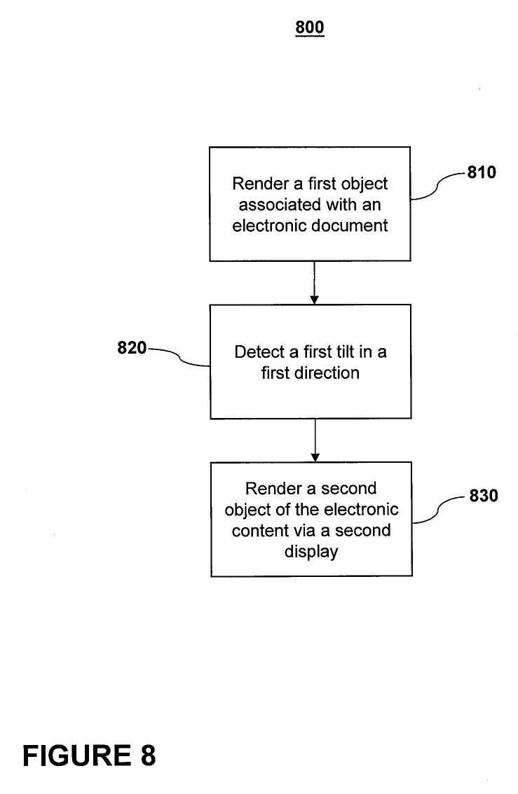

FIG. 8 depicts a flow diagram of another example method for interacting with content on a mobile device. The example method 800 may be implemented using, for example, the mobile device 100 described above with respect to FIGS. 1 and 7A-7G.

At 810, a first object of an electronic document may be rendered on a first display. For example, as described above, the mobile device such as the mobile device 100 may include a dual display. According to an example embodiment, the mobile device may render an electronic document such that the electronic document may be output to a user via the dual display. As described above, according to an example embodiment, the electronic document may include a plurality of objects. At 810, a first object of the plurality of objects may be rendered such that the first object may be output to the user via a first display 106A.

In one embodiment, the first object may be a first object in the electronic document. For example, as described above, the electronic document may be an electronic book. The first object may be the first page of the electronic book. According to another embodiment, the first object may be a previously viewed object. For example, the first object may be the last page viewed or read by the user of the electronic book before exiting the application such that may provide the electronic book to the user.

As shown in FIG. 7A, a first object 702 associated with an electronic document may be rendered at 810. For example, the mobile device 100 may render the first object 702 such that the first object 702 may be output to a user via the first display 106A. As described above, the electronic document may be an electronic book. As shown in FIG. 7A, the first object 702 may be the first page of the electronic book.

At 820, a first tilt in a first direction of the mobile device may be detected. For example, the user may perform one or more gestures with the mobile device to interact with the electronic document. As described above, the mobile device may include a dual display. For example, the mobile device may include a first display on one side of the mobile device and a second display the opposite side of the mobile device. The user may tilt the mobile device by in various directions to view the first and second displays and content such as objects that may be displayed thereon.

According to an example embodiment, the mobile device may detect the first tilt using via an accelerometer, or other suitable sensing device integrated therein, attached thereon, or the like as described above.

For example, as shown in FIG. 7B, a user may interact with the mobile device 100 by tilting the mobile device 100. In one embodiment, the user may tilt the mobile device 100 in a direction as indicated by the arrows 703 around the digital mobile device 100. As described above, the tilt may be sensed by the accelerometer 110 based on movement of the mobile device 100. According to an example embodiment, the touch input received at 820 may include the first direction of the tilt that may be associated with the user's interaction with the mobile device 100.

At 830, a second object may be rendered via the second display based on the first tilt in the first direction. For example, the mobile device may render the second object such that the second object may be output to the user via the second display.

As shown in FIG. 7C, the second object 706 such as a second page of an electronic book may be displayed on the second display 106B at 830 when the user tilts the mobile device 100 in a first direction at 820. According to one embodiment, rendering the second object 706 at 830 may be based on the speed and the direction of the tilt received. For example, as described above, the mobile device 100 may include a gestures application. The gestures application may receive the touch input to determine an action such as an object to render with respect to, for example, the electronic document. In an example embodiment, the gestures application may compare the speed and the direction of the tilt received at 820 with a list of suitable actions including, for example, scrolling from the first object 702 to the second object 706 shown in FIGS. 7A-7C.

The user may then view or read the second object 706, perform additional gestures such as tilting in the first direction again, tilting in a second direction, a third direction or the like, which may be received by the mobile device 100 as a second touch input to be directed to other objects in the electronic document, or perform any other suitable action to interact with the electronic document.

For example, in one embodiment, after the second object 706 may be rendered at 830 the user may tilt the mobile device 100 again in a first direction such that a second touch input may be received. As described above, the gestures application may receive the second touch input and may determine another object to render. For example, the second touch input may include a tilt in the same direction as the first tilt detected at 820 such that the first display 106A may be facing a user as shown in FIG. 7D. The gestures application may then use the direction of tilt detected to determine a third object 708 that may rendered by the mobile device 100 on the first display 106A as shown in FIG. 7E.

In another example embodiment, as shown in FIG. 7F, after the third object 708 may be rendered, the user may tilt the mobile device 100 again in a second direction such that a third touch input may be received. As described above, the gestures application may receive the third touch input and may determine another object to render. As shown in FIG. 7F, the user may tilt the mobile device 100 in a second direction as indicated by the arrows 705 around the mobile device 100 that may be in the reverse direction as the first direction of the first tilt. In an example embodiment, when the user tilts the mobile device 100 in the second direction, a previously viewed object such as a previously viewed page may be displayed as shown in FIG. 7G. For example, as shown in FIGS. 7E-7G, when the user tilts the mobile device 100 in the second direction the second object 706 may be re-displayed via the second display 106B.

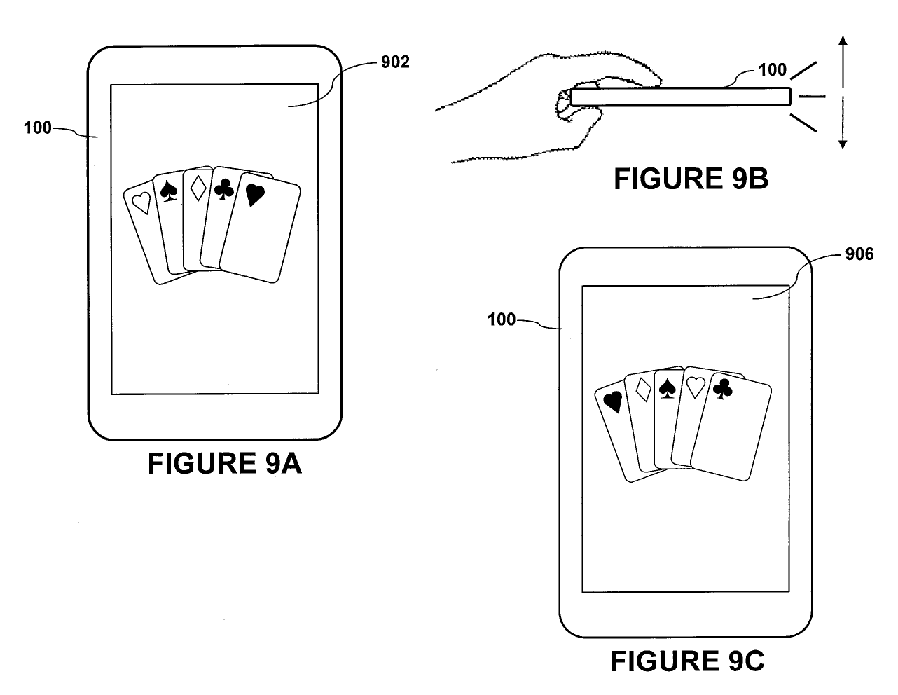

FIGS. 9A-9C depict another example embodiment of gestures with a mobile device 100 to interact with objects provided by an application. For example, as described above, the mobile device 100 may include an application such as an electronic game that may be provided to a user. In one embodiment, the mobile device 100 may render one or more interfaces for the application such that the interfaces may be output to the user via a display such as the display 106 described above with respect to FIG. 1. The user may then interact with the interfaces to, for example, execute the application.

According to an example embodiment, the application may include a plurality of objects that may be defined or arranged in a sequential order. For example, in one embodiment, the application may be a card game that may include a plurality of cards. The cards may be defined or arranged in a sequential order such that a first card may be followed by a second card, the second card may be followed by a third card, and so on. Thus, according to an example embodiment, the electronic content may include a plurality of objects that may be defined or arranged in a sequential order in a manner similar to a poker hand.

As described above, the user may perform one or more gestures with the mobile device 100 to interact with the interfaces including the plurality of objects provided by the application. For example, as shown in FIGS. 9B, a user may shake the mobile device 100. According to an example embodiment, the mobile device 100 may include an accelerometer 110, or other suitable sensing device therein or attached thereon such that a shake may be detected based on the up and down motion, left and right motion, or the like by the user of the mobile device 100. The detected shake may then be used to perform different actions such as changing the arrangement in which a set of objects are displayed, displaying one or more objects, displaying another set of objects, or the like provided by the application. For example, the user may shake the mobile device 100 up and down as shown in FIG. 9B to, for example, view different arrangements of the objects provided by the application via an interface, which will be described in more detail below.

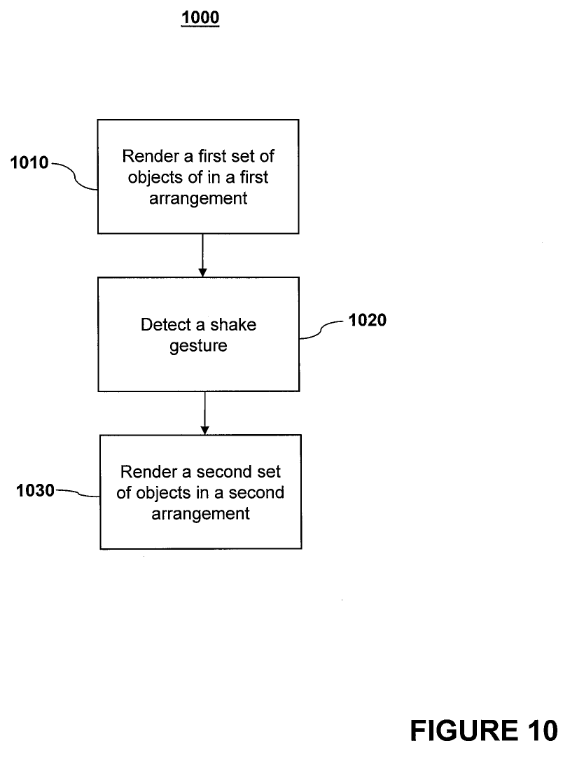

FIG. 10 depicts a flow diagram of an example method for interacting with content on a mobile device. The example method 1000 may be implemented using, for example, the mobile device 100 described above with respect to FIGS. 1 and 9A-9C. At 1010, a first set of objects associated with an application may be rendered in a first arrangement. For example, a mobile device may render one or more objects provided by the application in various arrangements via one or more interfaces that may be output to a user via a display. As described above, according to an example embodiment, the application may include a card game that may include a plurality of cards that may be defined or arranged in a sequential order. At 1010, a first set of cards such as a first hand of a new card game, a previous hand of, for example, a paused card game, or the like may be rendered in a first arrangement to the user via one or more interfaces that may be output to the display.

As shown in FIG. 9A, a first set of objects 902 associated with an application may be rendered at 1010. For example, the mobile device 100 may render the first set of objects 902 via one or more interfaces such that the first set of objects 902 may be output to a user via the display 106. As described above, the application may be a card game. As shown in FIG. 2A, the first set of objects 902 may be, for example, a hand of a new poker game.

Referring back to FIG. 10, at 1020, a shake gesture may be detected. For example, the user may perform one or more shake gestures with the mobile device to interact with the application. According to an example embodiment, the mobile device may receive the performed gestures via an accelerometer, or other suitable sensing device integrated therein, attached thereon or the like. That is, the user may interact with the accelerometer by, for example, shaking the mobile device in one direction or another. In one embodiment, the mobile device may detect the shake gesture including the speed of a shake; a direction of the shake; or the like such that the detected shake gesture may be used to modify the objects provided by the application.

For example, as shown in FIG. 9B, a user may interact with the mobile device 100 by shaking the digital device 100 up and down. According to an example embodiment, a shake gesture may be sensed by the accelerometer 110 based on movement of the mobile device 100. The user may shake the mobile device 100 in various directions at various speeds. For example, the user may shake the mobile device 100 in a up and down direction as indicated by the arrows shown in FIG. 9B. According to an example embodiment, the touch input received at 1020 may include the shake gesture as indicated by the arrows as shown in FIG. 9B.

Referring back to FIG. 10, at 1030, a second set of objects in a second arrangement may be rendered. For example, the mobile device may render a second set of objects via one or more interfaces such that the set of objects may be output to the user via the display. According to an example embodiment, the second set of objects may be rendered in the second arrangement in response to the detected shake gesture.

In one embodiment, the second set of objects may be different than the first set of objects. As described above, in one embodiment, the first set of objects may be a five card poker hand in a first turn of a card game. The second set of objects, for example, may be a subsequent five card poker hand in a second turn of the card game. In another embodiment, the second set of objects may be the same as the first set of objects, but displayed in the second arrangement that is different than the first arrangement. For example, the second set of objects may be the same five cards in the poker hand rendered at 1010, and only placed in a different arrangement, e.g. shuffled.

As shown in FIGS. 9A-9C, upon detecting a shake gesture at 1020, a second set of objects 906 may be rendered at 1030. As shown 9C, the second set of objects 906 may include the objects shown in FIG. 9A in a different arrangement, e.g., shuffled such that the objects may be in a different order.

After the second set of objects are rendered, the user may then view the second set of objects, perform additional gestures such as a shaking gesture that may be received by the mobile device 100 in a second touch input to be directed to other objects in the electronic document, or perform any other suitable action to interact with the electronic document. For example, in one embodiment, after the second set of objects may be rendered at 1030, the user may shake the mobile device. As described above, the gestures application may receive the second touch input and may determine another set of objects to render.

It should be understood that the various techniques described herein may be implemented in connection with hardware or software or, where appropriate, with a combination of both. Thus, the methods and apparatus of the subject matter described herein, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the subject matter described herein. In the case where program code is stored on media, it may be the case that the program code in question is stored on one or more media that collectively perform the actions in question, which is to say that the one or more media taken together contain code to perform the actions, but that—in the case where there is more than one single medium—there is no requirement that any particular part of the code be stored on any particular medium. In the case of program code execution on programmable computers, the computing device generally includes a processor, a storage medium readable by the processor (including volatile and non-volatile memory and/or storage elements), at least one input device 108, and at least one output device. One or more programs that may implement or utilize the processes described in connection with the subject matter described herein, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although example embodiments may refer to utilizing aspects of the subject matter described herein in the context of one or more stand-alone computer systems, the subject matter described herein is not so limited, but rather may be implemented in connection with any computing environment, such as a network or distributed computing environment. Still further, aspects of the subject matter described herein may be implemented in or across a plurality of processing chips or devices, and storage may similarly be affected across a plurality of devices. Such devices might include personal computers, network servers, handheld devices, supercomputers, or computers integrated into other systems such as automobiles and airplanes.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for interacting with content provided by a mobile device, the method comprising:
rendering a first object of a plurality of objects associated with an electronic document, wherein the plurality of objects associated with the electronic document are defined in a sequential order;
receiving a touch input, wherein the touch input comprises a pressure and a direction of a swipe on a touch surface;
determining a second object of the plurality of objects associated with the electronic document to render based on the pressure and direction of the swipe of the touch input, wherein the second object is not adjacent to the first object in the sequential order of the plurality of objects of the electronic document; and
rendering the second object.

2. The method of claim 1, further comprising scrolling from the first object to the second object.

3. The method of claim 2, wherein scrolling from the first object to the second object comprises skipping a number of objects of the plurality of objects between the first object and the second object in the sequential order.

4. The method of claim 3, wherein the number of objects is defined by the mobile device.

5. The method of claim 3, wherein the number of objects is user-defined.

6. The method of claim 2, wherein each of the objects between the first object and the second object are rendered when the first object is scrolled to the second object.

7. A mobile device, the mobile device comprising:
a display;
an input device;
a memory component configured to store program code and an electronic document that includes a plurality of objects;
a processor in operative communication with the display, the input device, and the memory component, wherein the processor executes the program code, and wherein execution of the program code directs the mobile device to:
render, via the display, a first object of the plurality of objects of the electronic document;
detect, via the input device, a first pressure associated with a touch input;
scroll a first number of objects of the plurality of objects from the first object to a second object based on the first pressure associated with the touch input;
render, via the display, the second object.

8. The mobile device of claim 7, wherein the first number of objects is defined by the mobile device.

9. The mobile device of claim 7, wherein the first number of objects is user-defined.

10. The mobile device of claim 7, wherein execution of the program code further directs the device to:
detect, via the input device, a second pressure associated with the touch input;
scroll a second number of objects of the plurality of objects from the second object to a third object based on the second pressure associated with the touch input;
render, via the display, the third object.

11. The mobile device of claim 10, wherein the second pressure associated with the touch input comprises a second force, and wherein the second force is greater than a first force of the first pressure associated with the touch input.

12. The mobile device of claim 10, wherein the second number of objects is greater than the first number of objects.

13. The mobile device of claim 10, wherein the second number of objects is defined by the mobile device.

14. The mobile device of claim 10, wherein the second number of objects is user-defined.

15. A computer-readable storage medium having computer-readable instructions for interacting with content on a mobile device, the computer-readable instructions comprising instructions for:
rendering a first object of electronic content on a first display;
detecting a first tilt in a first direction of the mobile device; and
rendering a second object of the electronic content via a second display based on the detection of the first tilt in the first direction.

16. The computer-readable storage medium of claim 15, wherein the electronic content comprises a plurality of objects in a sequential order.

17. The computer-readable storage medium of claim 16, wherein the first object is adjacent to the second object in the sequential order.

18. The computer-readable medium of claim 16, further comprising instructions for:
detecting a second tilt in the first direction; and
rendering a third object of the electronic document via the first display based on the detection of the second tilt in the first direction.

19. The computer-readable medium of claim 18, wherein the third object is adjacent to the second object in the sequential order.

20. The computer readable medium of claim 19, further comprising instructions for:
detecting a third tilt in a second direction; and
rendering the second object of the electronic document via the second display based on the detection of the third tilt in the second direction.

21. A mobile device, the mobile device comprising:
a display;
an accelerometer;
a memory component configured to store program code and an application;
a processor in operative communication with the display, the accelerometer, and the memory component, wherein the processor executes the program code, and wherein execution of the program code directs the mobile device to:
render, via the display, a first set of objects associated with the application, wherein the first set of objects comprises a first arrangement;
detect, via the accelerometer, a shake gesture with the mobile device; and
render, via the display, a second set of objects associated with application, wherein the second set of objects comprises a second arrangement that is different than the first arrangement of the first set of objects.

22. A computer-implemented method for interacting with content on a mobile device, the method comprising:
rendering a first object of a plurality of objects associated with an electronic document, wherein the plurality of objects associated with the electronic document are defined in a sequential order;
detecting a direction of a swipe and a pressure on a touch surface; and
scrolling, in the direction of the swipe, through a portion of the plurality of objects in the sequential order when the pressure is maintained on the touch surface, wherein the portion of plurality of objects begins with the first object.

23. The method of claim 22, further comprising rendering a second object of the plurality of objects when the pressure is not maintained, wherein the second object is adjacent in the sequential order to a last object scrolled through in the portion of the plurality of objects.

24. The method of claim 22, further comprising determining whether the pressure exceeds a threshold pressure, wherein the portion of the plurality of objects in the sequential order are scrolled, in the direction of the swipe, when the pressure maintained on the touch surface exceeds the threshold pressure.
